(19) United States
(12) Patent Application Publication
(10) Pub. No.: US 2005/0062450 A1
(43) Pub. Date: Mar. 24, 2005

(54) Rotor resistance estimation by calibrated measurement of stator temperature

(76) Inventor: Gary Pace, Cypress, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/918,661

(22) Filed: Aug. 13, 2004

Related U.S. Application Data
(60) Provisional application No. 60/481,230, filed on Aug. 14, 2003.

(51) Int. Cl. H02P 7/00

(52) U.S. Cl. 318/432

(57) ABSTRACT

A method of estimating rotor resistance by calibrated measurement of stator temperature is provided. The temperature of the stator winding may be monitored using a suitable device (thermistor, RTD etc). This temperature signal is used to “look up” the correct value of Rr for the current temperature. The “look up” characteristic is a calibrated table, whose values are learned during a prolonged test whereby actual (measured) motor torque is controlled to a correct demanded value by adaptation of the Rr parameter, as the motor temperature varies from cold to hot. The stator temperature feedback during the test provides the X-axis values of the look up table, and the correctly adapted Rr value provides the Y-axis values.

### BACKGROUND OF THE INVENTION

1. Field of the Invention

This application claims priority to the Provisional Application 60/481,230, entitled “Rotor Resistance Estimation by Calibrated Measurement of Stator Temperature” filed Aug. 14, 2003, incorporated herein in its entirety by reference.

2. Description of the Related Art

Induction motors controlled using variable speed drives employing Vector Control are widely used across all industries. A major objective of this control method is the fast and accurate control of motor. In many applications this is the critical control objective.

When using Vector Control, torque accuracy is significantly impaired by inaccuracy in the controller's estimation of the motor's rotor resistance (Rr). Rotor resistance for an individual machine can be measured, but this value varies by typically 40% of its cold value at normal operating temperatures.

Current techniques for dealing with this problem are generally Model Reference Adaptive Systems (MRAS), whereby errors in modeled and actual motor voltage are nulled to zero by adaptation of the Rr parameter in the controller model. These techniques work well when the motor is operating at significant speed. At low speeds, the motor voltage is small, and hence the signal to noise ratio of values driving the MRAS may not allow for accurate adaptation of the Rr parameter.

### SUMMARY OF THE INVENTION

A method of estimating rotor resistance by calibrated measurement of stator temperature is described. Further, a method of controlling an induction motor with Model Reference Adaptive Systems, for reducing errors between modeled and actual motor voltage by utilizing a Rotor Resistance (Rr) parameter is also described. The Rr utilized may be based on motor temperature, and may be determined by utilizing a calibration or “look up” table based on said temperature to determine the correct Rr parameter.

### DESCRIPTION OF ILLUSTRATIVE EMBODIMENTS

Illustrative embodiments of the invention are described below as they might be employed in motor control. In the interest of clarity, not all features of an actual implementation are described in this specification. It will of course be appreciated that in the development of any such actual embodiment, numerous implementation-specific decisions must be made to achieve the developers' specific goals, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following descriptions and drawings.

In the practice of the present invention the temperature of the stator winding is monitored using a suitable device (thermistor, RTD, etc). This temperature signal is used to “look up” the correct value of Rr for the current temperature. The “look up” characteristic is a calibrated table, whose values are learned during a prolonged test whereby actual (measured) motor torque is controlled to a correct demanded value by adaptation of the Rr parameter, as the motor temperature varies from cold to hot. The stator temperature feedback during the test provides the X-axis values of the look up table, and the correctly adapted Rr value provides the Y-axis values.

Because a mismatch in measures stator temperature and actual rotor temperature may render this technique invalid, it is proposed to use this technique only at very low speeds (where a good correlation between stator and rotor temperatures is expected), and to revert to a standard MRAS technique at higher motor speeds.

Although various embodiments have been shown and described, the invention is not so limited and will be understood to include all such modifications and variation as would be apparent to one skilled in the art.

1. All new and nonobvious apparatus disclosed herein.

2. The apparatus of claim 1 wherein the apparatus is a motor employing a model reference adaptive systems.

3. All new and nonobvious methods disclosed herein.

4. A method of controlling an induction motor with Model Reference Adaptive Systems including a Rotor Resistance (Rr) parameter, comprising:
determining the correct Rr parameter based on motor temperature.

5. The method of claim 4 in which the step of determining the correct Rr parameter comprises utilizing a calibration table to select the Rr parameter based on motor temperature.

6. The method of claim 5 wherein the motor temperature is based on the temperature of a stator winding of the motor.

7. The method of claim 6, further comprising
generating the calibration table, by,
measuring torque of the motor;
controlling the torque to a demanded value by changing the Rr parameter over time as the stator temperature increases;
recording the value of temperature over time;
recording the values of Rr parameters over time;
generating the calibrated table by plotting Rr against stator temperature.

8. The method of claim 7 wherein the method is utilized below a given motor speed.

9. The method of claim 8 wherein the method is not utilized above the given motor speed.

10. The method of claim 9 wherein the value of Rr plotted against the stator temperature is determined by an equation.
